(19) United States
(12) Patent Application Publication
(10) Pub. No.: US 2008/0284337 A1
(43) Pub. Date: Nov. 20, 2008

(54) Ceramic Metal Halide Discharge Lamp

(75) Inventor: Josephus Christiaan Maria Hendricx, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/570,348

(22) PCT Filed: Jun. 9, 2005
(86) PCT No.: PCT/IB05/51895

§ 371 Date: Dec. 11, 2006

(30) Foreign Application Priority Data
Jun. 14, 2004 (EP) 04102688.1

(51) Int. Cl. H01J 17/18

(52) U.S. Cl. 313/625

(57) ABSTRACT

The invention relates to a high-pressure discharge lamp comprising a ceramic discharge vessel which encloses a discharge space, which is provided with an ionizable filling comprising one or more metal halides, in which a first and a second electrode are arranged, and which comprises a first and a second closing construction at respective sides of the discharge space, which closing constructions are connected to the discharge vessel and comprise a respective first and second current feed-through, at least the second feed-through comprising a capillary tube having a sintered bond to the second closing construction and an electrically conductive pin located within the capillary tube, leaving a crevice between the capillary tube and the pin, said pin and capillary tube being welded together at an end portion remote from the discharge space, wherein the capillary tube has an outer diameter of at most 1 mm, the crevice is at most 10 μm wide and the pin and the capillary tube consist of a metal chosen from Mo, Re, W, Ir, their alloys, optionally also comprising V and/or Ti. The invention further relates to an automotive lamp comprising the lamp of the invention.

The invention relates to a high-pressure discharge lamp comprising a ceramic discharge vessel which encloses a discharge space, which is provided with an ionizable filling comprising one or more metal halides, in which a first and a second electrode are arranged, and which comprises a first and a second closing construction at respective sides of the discharge space, which closing constructions are connected to the discharge vessel and comprise a respective first and second current feed-through, at least the second feed-through comprising a capillary tube having a sintered bond to the second closing construction and an electrically conductive pin located within the capillary tube, leaving a crevice between the capillary tube and the pin, said pin and capillary tube being welded together at an end portion remote from the discharge space. The invention relates in particular to an automotive headlight discharge lamp.

Automotive headlight discharge lamps contain fillings which comprise besides Xe gas, also metal halide salt mixtures such as NaCe, NaPr, NaLu and NaNd iodide, or combinations of these salts. These salt mixtures are applied to obtain inter alia a high lamp efficacy.

A disadvantage of lamps with this type of salt mixtures is that a temperature gradient in the closing constructions on either side of the discharge space cause various amounts of different salt components to be transported into the crevice between the capillary tube and the electrically conductive pin. The resulting de-mixing of the salt components causes color instability during lamp operation and a color point shift during the lifetime of the lamp.

An example of a lamp of the kind set forth in the description of the field of the invention is known from U.S. Pat. No. 6,181,065. The lamp described in FIG. 3 of U.S. Pat. No. 6,181,065 has a cermet capillary tube. Cermet is a material consisting of processed ceramic particles bonded with metal and suitable for high-temperature applications.

A disadvantage of the known lamp is that a poorly controlled shrinkage of the cermet tube during its manufacture renders it difficult to obtain a well-defined inner tube dimension. Therefore, a wide crevice between the tube and the electrically conductive pin is actually unavoidable in series production. A wide crevice, however, promotes de-mixing of salt components.

Another disadvantage of a cermet tube is its porous structure. Especially at the required thin walls (50-200 μm) for automotive burners, it is difficult to sinter the cermet tubes vacuum-tight, as a consequence of which highly pressurized Xe gas inside the lamp may leak out of the lamp.

An object of the invention is to provide a high-pressure discharge lamp filled with salt mixtures giving a high efficacy and having an improved color stability during lamp operation and during the life of the lamp.

Another object of the invention is to provide a lamp which can easily be mass produced.

A further object of the invention is to provide a lamp which is less permeable to gases.

These and other objects of the invention are achieved by a high-pressure discharge lamp according to claim 1.

The lamp according to the invention, has a crevice of at most 10 μm width between the capillary tube and the pin. No salt components are found in such small crevices, whereas in conventional end constructions with crevices of about 30 μm salt components are always found. So the pin and tube construction of the present invention avoids salt creeping into the extremely small crevices, solving the appearance of color instabilities of the lamp.

As used herein, “ceramic” means a refractory material such as a mono-crystalline metal oxide (e.g. sapphire), polycrystalline metal oxide (e.g. polycrystalline densely sintered aluminum oxide and yttrium oxide), and polycrystalline non-oxidic material (e.g. aluminum nitride). Such materials allow wall temperatures of 1500-1700 K and resist chemical attacks by halides and Na. For the purposes of the present invention, polycrystalline aluminum oxide (PCA) has been found to be most suitable.

The ceramic discharge vessel may be a tube, or may alternatively have a barrel shape, and it may be produced by a known casting technique, for example slip-casting. The closing construction may be a plug which is co-sintered with the vessel, or the closing construction and the vessel may be part of one slip-cast body.

A further advantage of the lamp of the invention is the simplicity of its production method. A semi-finished article comprising the ceramic discharge vessel provided with a first electrode and a current feed-through connected in a gastight manner to a first closing construction, and the capillary tube in the second closing construction can be prepared easily off line in a first production step. In a second production step, the semi-finished article is filled with the ionizable filling through the capillary tube in the second closing construction. After insertion of the electrode, the tube and the electrode can be welded under Xe pressure in a final production step of the lamp. The advantage of the welding construction is that a substantial temperature rise of the lamp can be avoided in the welding process, made possible by the construction of the lamp of the invention. This prevents an escape of gases from the lamp during the welding process. The fast welding may advantageously be carried out with a laser pulse, which renders possible a mass production of lamps according to the invention with a Xe pressure of more than 0.5 MPa. It has been shown that lamps according to the invention with Xe pressures of up to 3-4 MPa can still be mass produced by the technique described.

Another advantageous feature of the present invention is the vacuumtightness of the sintered bond of the capillary tube in the second closing construction. The tube is co-sintered with a pre-fired closing construction, thus forming a vacuumtight shrink fit (sfit) sintered bond connection. Although alumina has a higher thermal expansion coefficient (TEC) than the metal tube, the sintered bond connection thus achieved is vacuumtight, even at the high operating temperatures of the lamp. Without pretending to give a scientific explanation, the vacuumtightness of the shrink-fit sintered bond connection of the present invention can be understood to result from the fact that during cooling-down after the co-sintering process, the metal tube is subject to an elastic deformation, obviously without substantial yield. This deformation of the tube, with an outer diameter of at most 1 mm, prevents the formation of cracks in the alumina, which has a higher TEC than the metal, but elastic stresses are building up in the tube during cooling. Heating the lamp to its operating temperature does not cause leakage either, due to the release of the elastic stress in the metal tube, thus maintaining a tight connection between the tube and the ceramic closing construction.

Surprisingly, the temperature dependence of the elastic modulus and yield stress of tubes of Mo, Re, W, Ir, their alloys, optionally also comprising V and/or Ti, are such that during sintering and subsequent cooling-down of the shrink-fit sintered bond connection enough elastic stresses are being built up to compensate for the difference in thermal expansion coefficients between the ceramic closing construction and the metal tube when the temperature of the lamp rises to its operating temperature. A tube of Mo, or its alloys, is preferably a drawn tube. With a drawn Mo tube an even longer lifetime and number of switching cycles is obtained.

The first feed-through may be any conventional feed-through. Preferably, the first feed-through comprises a first halide-resistant conductor, for example a Mo-rod adjacent to the electrode, and a second conductor, for example comprising Nb, Mo, W, wherein the first conductor has a diameter of at most 0.5 mm and has a sintered connection over a portion of its length adjacent to the electrode to a first part of the first closing construction, leaving a space between the remaining portion of its length, the second conductor, and a second part of the first closing construction, which space is filled with a ceramic sealing material, for example sealing glass. The ceramic sealing glass generally comprises a mixture of oxides. A preferred embodiment of the sealing glass has a composition consisting of an Al₂O₃:SiO₂:Dy₂O₃ mixture and extends over a length of approximately 1-3 mm. This extension of the sealing glass into the small gap is realized during lamp manufacture through localized heating of the closing construction. The sealing glass covers the second conductor to a large extent and even part of the first conductor, thus protecting the second conductor from a chemical reaction with the halides, which may enter via microcracks possibly formed in the sintered connection between the first halide-resistant conductor and the first closing construction.

A halide-resistant conductor is manufactured from a material which comprises at least one of the metals from the group formed by tungsten, molybdenum, rhenium, their alloys, and/or an electrically conducting silicide, carbide, or nitride of at least one of these metals.

The invention further relates to an automotive headlight discharge lamp comprising a lamp according the invention. The lamp of the invention will normally be suspended in an automotive lamp by its tube. An advantage of an automotive lamp according to the invention is the higher fatigue resistance of the capillary tube made from Mo, Re, W, Ir, their alloys, optionally also comprising V and/or Ti, with respect to the known cermet tube. A higher fatigue resistance is also beneficial for a longer lifetime of the lamp.

The above and further aspects of the invention will be explained in more detail below with reference to a drawing in which:

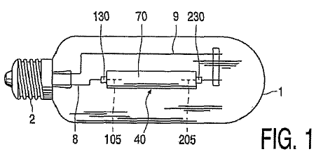

FIG. 1 shows a lamp according to the invention;

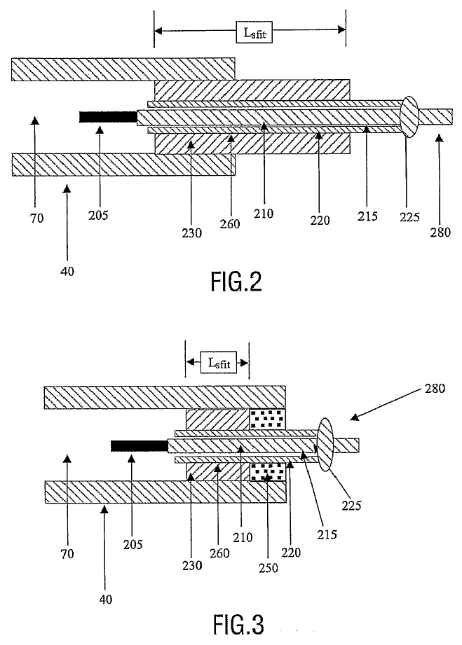

FIGS. 2-5 show examples of schematic views of cross-sections of the seal of the second feed-through of lamps according to the invention, and

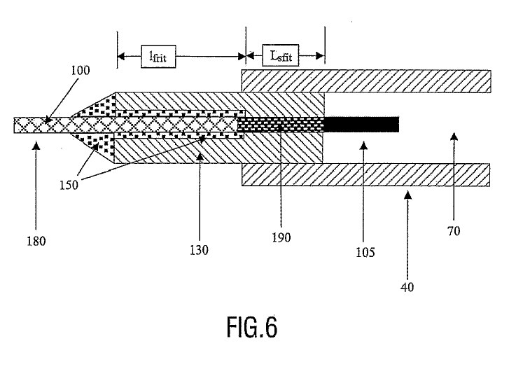

FIG. 6 is an example of a schematic view of a cross-section of the seal of the first feed-through of the lamp according to FIG. 1.

For a general construction of an automotive lamp, reference is made to e.g. U.S. Pat. No. 4,475,061.

FIG. 1 shows a metal halide lamp provided with a discharge vessel 40 having a ceramic wall which encloses a discharge space 70 containing an ionizable filling. First and second tungsten electrodes 105, 205 are arranged in the discharge space so as to define a discharge path between them. The discharge vessel is closed at either side of the discharge space by means of a first and a second closing construction of a ceramic projecting plug 130, 230 which encloses a current lead-through conductor (FIG. 2: 180, 280) to the respective first and second electrode 105, 205. The discharge vessel is surrounded by an outer bulb 1 which is provided with a lamp cap 2 at one end. A discharge will extend between the electrodes 105, 205 when the lamp is operating. The electrode 105 is connected via a current conductor 8 to a first electrical contact forming part of the lamp cap 2. The electrode 205 is connected to a second electrical contact forming part of the lamp cap 2 via a current conductor 9.

FIG. 2, highly schematically, illustrates the seal of the second feed-through (280) of the lamp according to the invention as shown in FIG. 1. The lamp comprises a ceramic discharge vessel (40) into which the second closing construction, here being a projecting plug (230), is sintered. This plug preferably consists of the same material as the ceramic discharge vessel. The second closing construction (230) is co-sintered with the metal capillary tube (220), thus forming a shrink-fit sintered bond connection (260). The capillary tube preferably has an inner diameter of about 320 μm.

The length of the shrink-fit sintered bond connection, in FIG. 1 denoted by L_{sfit}, should preferably be between 1 mm and 4 mm.

FIG. 2 further shows the discharge space (70) between the first (not shown) and the second electrode (205). The capillary metal tube (220) is separated from the electrically conductive pin (210) by a crevice (215) of at most 10 μm width. The conductive pin (210), preferably having a diameter of about 300 μm, and the metal tube (220) are connected by a weld (225).

FIG. 3 illustrates another embodiment of a second feed-through, in which the shrink-fit sintered bond connection is combined with a frit connection comprising a ceramic sealing material (250). The TEC of the material used for the frit connection is preferably about the average of the TECs of the metal tube and the ceramic vessel. This hybrid seal connection can be shorter than a connection with a shrink-fit sintered bond connection alone.

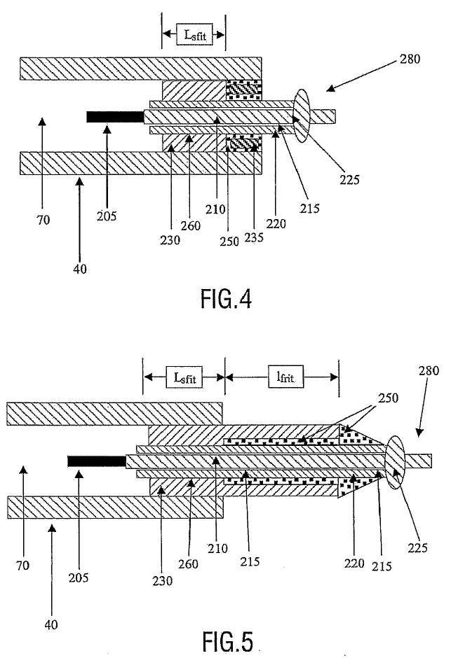

FIG. 4 shows a further improvement of the connection in the sense that the ceramic sealing material encloses a ceramic ring (235). This ceramic ring is preferably of the same material as the vessel and the closing construction. With this ceramic ring, inclusion of gas pockets are avoided due to capillary forces in the gaps, with a width of not more than 50 mm, preferably not more than 30 μm between ring and vessel on the one side and ring and tube on the other side. A ceramic ring also prevents a high stress level from being built up in the sealing glass and in the closing construction around the frit connection.

FIG. 5 shows a modification of the above-mentioned ceramic ring, in the sense that a ceramic sealing material (250) at least partly fills a space between the capillary tube and the second closing construction over a distance l_{frit}, remote from the discharge space. This arrangement also allows a short sealing length. This embodiment has the advantage that, even if the first shrink-fit sintered bond connection does not stay vacuumtight under frequent switching conditions, the frit connection does. The lengths of the shrink-fit sintered bond connection (l_{sfit}) and of the frit connection (l_{frit}) should be chosen such that cracks in the frit connection are always avoided. Suitable lengths for the shrink-fit and the frit connection are about 2 and 2 to 4 mm respectively. The lamp will stay vacuumtight then, even in the case of small cracks in the shrink-fit sintered bond connection. In this end construction the total connection length (l_{frit}+l_{sfit}) should be as small as possible (short burner length), or in other words should be so small that the required lamp life and number of switching cycles are achieved. With this type of connections a lamp life of 2500-3000 h with more than 40,000 switching cycles can be obtained.

FIG. 6 shows a possible first sealing. Here a feed-through (180) preferably consisting of 3 parts (e.g. W—Mo—Nb) is attached to the first closing construction (130), which is sintered into the ceramic discharge vessel (40). Part of a Mo-rod (190) adjacent to the electrode (105) has a sintered connection to the first closing construction (130) as described above. The remaining crevice between the Nb-rod, part of the Mo-rod, and the closing construction is filled with sealing frit (150).

If the shrink-fit sinter connection does not stay vacuumtight during frequent switching, the frit connection will. The lengths of the shrink-fit sintered connection (l_{sfit}) and the frit connection (l_{frit}) should be such that salt components cannot seriously attack the sealing frit, not even in the case of small cracks in the shrink-fit sintered connection. A length of at least 2 mm for the sealing frit is preferred to keep the temperature of the frit at a value low enough to avoid cracks caused by different shrinkages of rod and closing construction. The total connection length (l_{frit}+l_{sfit}) should be as small as possible to obtain a short length of the lamp, or in other words should be such that the required lamp life and number of switching cycles are achieved.

1. A high-pressure discharge lamp comprising a ceramic discharge vessel (40) which encloses a discharge space, which is provided with an ionizable filling comprising one or more metal halides, in which a first (105) and a second electrode (205) are arranged, and which comprises a first (130) and a second closing construction (230) at respective sides of the discharge space (70), which closing constructions are connected to the discharge vessel and comprise a respective first (180) and second current feed-through (280), at least the second feed-through (280) comprising a capillary tube (220) having a sintered bond to the second closing construction (230) and an electrically conductive pin (210) located within the capillary tube, leaving a crevice (215) between the capillary tube and the pin, said pin and capillary tube being welded together (225) at an end portion remote from the discharge space, wherein the capillary tube has an outer diameter of at most 1 mm, the crevice is at most 10 μm wide, and the pin and the capillary tube consist of a metal chosen from Mo, Re, W, Ir, their alloys, optionally also comprising V and/or Ti.

2. A lamp according to claim 1, wherein a ceramic sealing material (250) fills at least partly a space enclosed by the discharge vessel, the capillary tube, and the external side of the second closing construction.

3. A lamp according to claim 2, wherein the ceramic sealing material encloses a ceramic ring (235).

4. A lamp according to claim 1, wherein a ceramic sealing material (250) at least partly fills a space between the capillary tube and the second closing construction remote from the discharge space.

5. A lamp according to claim 1, wherein a first current feed-through (180) comprises a first halide-resistant conductor (190) adjacent to the first electrode (105) and a second conductor (100), for example comprising Nb, Mo, W, wherein the first conductor has a diameter of at most 0.5 mm and has a sintered connection, extending over a portion of its length adjacent to the electrode, with a first part of the first closing construction, thus leaving a space enclosed by the remaining part of its length, the second conductor, and a second part of the first closing construction, which space is filled up with a ceramic sealing material (150).

6. A lamp according to claim 5, wherein the ceramic sealing material around the second conductor extends beyond the first closing construction.

7. Automotive headlight discharge lamp, comprising a lamp according to claim 1.
